(19) United States
(12) Patent Application Publication
(10) Pub. No.: US 2022/0338629 A1
(43) Pub. Date: Oct. 27, 2022

(54) Wall Plate Holder for Phones & Tablets

(71) Applicants: Patricia M. Perez, Coral Springs, FL (US); Jaime A. Perez, Coral Springs, FL (US)

(72) Inventors: Patricia M. Perez, Coral Springs, FL (US); Jaime A. Perez, Coral Springs, FL (US)

(21) Appl. No.: 17/238,950

(22) Filed: Apr. 23, 2021

(51) Int. Cl. A47B 96/02; H02G 3/14

(52) U.S. Cl. CPC A47B 96/027; H02G 3/14

(57) ABSTRACT

Supports on top of a cover plate to hold cellular phones and tablets vertically or horizontally while charging devices or just hold devices (to watch a movie, listen to music or more), organize devices and cables, and keep devices away from hazardous danger including flammable objects or water damage. These supports may be used in different types of cover plates to fit specific kinds of outlets, switches, or the like. The outlets could be round, square or rectangle. The cover plate with supports has excellent features suitable for people of all ages and may be used anywhere you would put a cover plate. The countersunk fastener apertures have four additions to keep fasteners from falling out and reinforcements on the back to strengthen the cover plate and supports to be able to hold cellular phones and tablets.

### CROSS-REFERENCE TO RELATED APPLICATIONS

This application claims the benefit of U.S. Application Data Ser. No. 17/238,950 filed on Apr. 23, 2021 for Non Provisional Patent and related U.S. Application Data 63/101,343 filed on Apr. 27, 2020 for Provisional Patent.

### BACKGROUND OF THE INVENTION

### Technical Field

The present embodiments relate to the field of mounting electrical devices on the wall.

### SUMMARY OF INVENTION

According to an embodiment, supports are placed on top of a cover plate to hold cellular phones and tablets vertically or horizontally while charging devices or just hold devices (to watch a movie, listen to music or other), and organize devices and cables. Supports keep devices away from hazardous danger including flammable objects or water damage.

According to a further embodiment, these supports may be used in different types of cover plates to fit specific kinds of outlets and accommodate different kinds of switches and data jacks or the like (a wall plate of a 1-gang duplex outlet as well as 2-gang duplex, 3-gang duplex, or 4-gang duplex outlets, and/or in a combination of a variety of outlets and switches). The outlets could be round, square or rectangle.

According to another further embodiment, the countersunk fastener apertures have four additions to keep the fasteners from falling out.

According to an even further embodiment, reinforcements have been placed on the back to strengthen the cover plate and supports to be able to hold cellular phones and tablets.

### BRIEF DESCRIPTION OF THE DRAWINGS

FIG. 1 is a front perspective view of supports on the top of a cover plate.

FIG. 2 is an enlarged partial section of the front perspective view of supports on the top of the cover plate. It also includes two types of cover plates to illustrate the different types of cover plates that may be used, and including an enlarged view of one or more countersunk fastener apertures. Said countersunk fastener aperture or apertures have four additions to keep fasteners from falling out.

FIG. 3 is a side view of the supports on a cover plate.

FIG. 4 is a rear perspective view of the cover plate including reinforcements to strengthen the cover plate and supports to be able to hold the weight of cellular phones and tablets.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

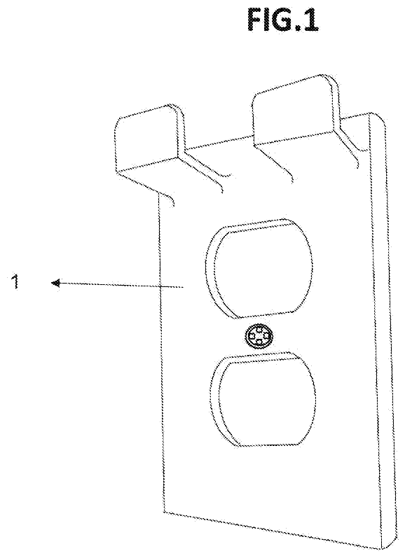

FIG. 1 illustrates supports on top of a cover plate 1 mounted to a wall to hold cellular phones or tablets. Although a 1-gang duplex outlet is illustrated, any electrical device may be employed, such as a combination of outlets and switches, or the like. Wall mounted electrical devices are usually standardized; however, although our invention may be standardized, the height and width of the device may be increased and sized to effectively cover an electrical wall box opening.

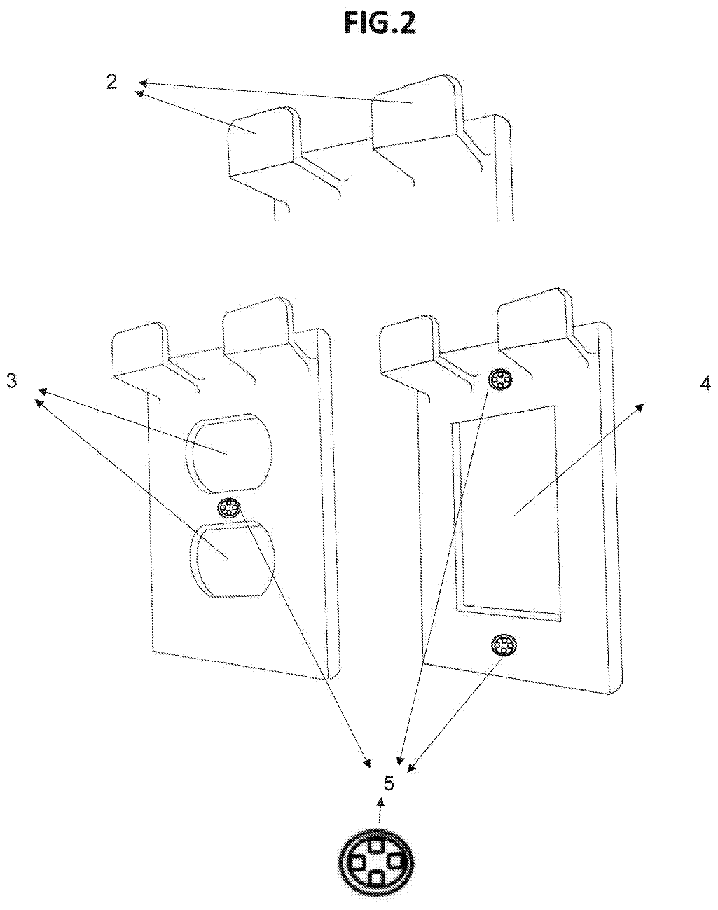

Referring to FIG. 1 thermoplastic material used to manufacture the cover plate to be in compliance with the material used in electrical boxes. In order to manufacture the cover plate with supports, a mold have been made of steel with cavities depending on specific wall mounted electrical device specified on FIG. 2. The thermoplastic material is injected in a liquid form into the mold after heating it. Then it has to be cooled down. This entire process takes around 30 seconds to make one cover plate with supports. Suitable materials may include acrylonitrile butadiene styrene (ABS), polypropylene, or nylon materials, or the like.

Referring again to FIG. 1, the installation of the cover plate including supports is simple. The user needs to replace his/her old cover plate with the screw(s) provided, depending on the wall mounted electrical device that they own.

FIG. 2 illustrates partial and not to scale supports on the top front of said cover plate to hold cellular phones or tablets up to 1.5 lbs. and at the same time organize and charge devices. Although only two cover plates have been included below the supports 2 as representation, any cover plate can be employed 3 & 4, such as a combination of outlets and switches, or the like, including 1-gang duplex outlet as well as 2-gang duplex, 3-gang duplex, or 4-gang duplex outlets, and/or in a combination of a variety of outlets and switches. A cover plate including countersunk screw aperture or apertures whereby includes four additions 6 to secure and tight screws to avoid said screws to fall out. The head of the screws will sit below the surface of the material.

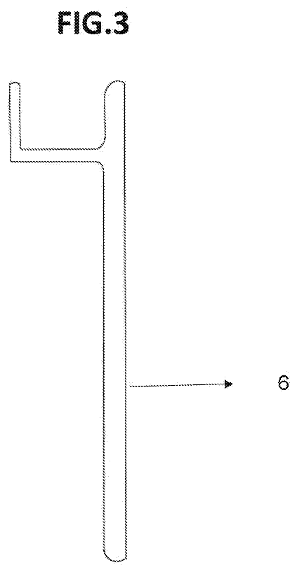

FIG. 3 illustrates the side view of the supports 2 including the cover plate 6 to hold cellular phones or tablets.

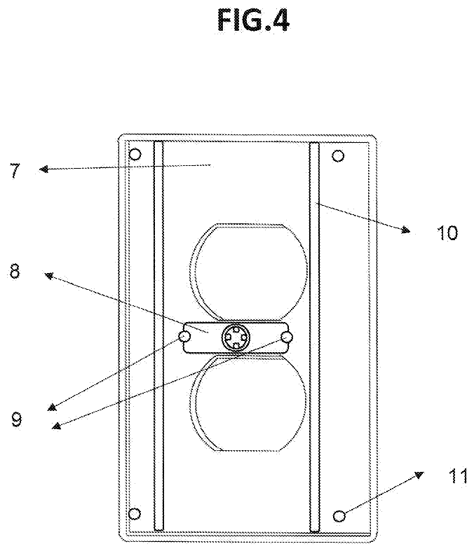

FIG. 4 illustrates the rear perspective view of the wall mounted device 7. Although a 1-gang duplex outlet is illustrated, any electrical device may be employed, such as a combination of outlets and switches, or the like. The cover plate including reinforcements on the rear perspective side to strengthen the cover plate and supports to be able to hold the weight of cellular phones and tablets. FIG. 4 also illustrates reinforcements in the middle of the cover plate including one rectangular reinforcement 8 around the countersunk fastener aperture and two round reinforcements 9 on the sides of said rectangular reinforcement. FIG. 4 also illustrates two rectangular reinforcements on the left and right side of the cover plate from top to bottom 10. FIG. 4. also illustrates four round reinforcements on each side of the cover plate 11.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. Supports comprising of additions to the top of a cover plate to hold devices and may be used in a combination of a variety of cover plates, switches or the like, including one or more countersunk screw apertures to tight said cover plate to the electrical box and reinforcements on the rear side to strengthen the cover plate and supports to be able to hold the weight of the devices.
